(19) United States
(12) Patent Application Publication
(10) Pub. No.: US 2017/0220413 A1
(43) Pub. Date: Aug. 3, 2017

(54) MEMORY SYSTEM, SEMICONDUCTOR MEMORY DEVICE AND OPERATING METHOD THEREOF

(71) Applicant: SK hynix Inc., Gyeonggi-do (KR)

(72) Inventors: Jae-Won CHA, Gyeonggi-do (KR); Jae-Woo PARK, Gyeonggi-do (KR)

(21) Appl. No.: 15/174,715

(22) Filed: Jun. 6, 2016

(30) Foreign Application Priority Data
Jan. 28, 2016 (KR) 10-2016-0010719

(51) Int. Cl. G06F 11/10; G06F 3/06

(52) U.S. Cl. CPC G06F 11/1064; G06F 3/0619; G06F 3/064; G06F 3/0679

(57) ABSTRACT

A semiconductor memory device may include: a memory cell array comprising: a Content Addressable Memory (CAM) cell block including CAM cells storing option Information including operation setting information for controlling an operation of the semiconductor memory device, and error check information for the operation setting information; and memory blocks including memory cells for storing data; an error detection unit suitable for reading out, in response to a CAM read command, the operation setting information and the error check information stored in the CAM cell block and outputting an error detection signal indicating whether there is an error; and a control logic suitable for determining and outputting a state of a ready/busy signal depending on the error detection signal.

### CROSS-REFERENCE TO RELATED APPLICATION

This application claims priority under 35 U.S.C. §119 to Korean Patent Application No. 10-2016-0010719 filed on Jan. 28, 2016 with the Korean Intellectual Property Office, which is incorporated herein by reference in its entirety.

### TECHNICAL FIELD

Exemplary embodiments of the present invention relate generally to a semiconductor design technology, and more particularly, to a semiconductor memory device which performs a Content Addressable Memory (CAM) read operation, and a memory system including the same.

### DISCUSSION OF THE RELATED ART

Semiconductor memory devices are broadly categorized into a volatile memory device and a nonvolatile memory device.

The volatile memory device has generally higher write and read speed, but loses data stored therein when a power supply is turned off. The nonvolatile memory device has comparatively low write and read speed, but retains data stored therein even when a power supply is turned off. Therefore, the nonvolatile memory device is used in order to store data which should be retained regardless of whether a power is supplied. Examples of the nonvolatile memory device may include a ROM (Read Only Memory), an MROM (Mask ROM), a PROM (Programmable ROM), an EPROM (Electrically Programmable ROM), an EEPROM (Electrically Erasable Programmable ROM), a flash memory, a PRAM (Phase Change Random Access Memory), an MRAM (Magnetic RAM), an RRAM (Resistive RAM), and an FRAM (Ferroelectric RAM). The flash memory is classified into a NOR type and a NAND type.

A flash memory combines advantages of a RAM in that data is programmable as in a RAM and can retain data stored therein even when a power supply is turned off like a ROM. Hence, the flash memory is widely used as a storage medium of a portable electronic device such as a digital camera, a PDA (Personal Digital Assistant) and an MP3 player.

Meanwhile, a semiconductor memory device separately stores various kinds of option information needed for the operation thereof. The option information includes essential information such as operation setting information for controlling program, read or erase operation, repair address information and bad block information. The semiconductor memory device uses Content Addressable Memory (CAM) cells to store the option information. If option Information is stored in CAM cells, it is easy to correct option information even after a packaging process, and it is possible to reduce the size of a semiconductor memory device because a fuse unit having a large size is not used.

FIGS. 1A and 1B are a flow chart and a timing diagram for describing a CAM read operation of a semiconductor memory device in accordance with the prior art.

Referring to FIG. 1A, when an external power supply voltage begins to be supplied to the semiconductor memory device at Step S100, a CAM read command for reading out option information stored in CAM cells is inputted from an external controller at Step S110.

In response to the CAM read command, the semiconductor memory device reads out, the option information stored in the CAM cells. In this regard, among the option information, operation setting Information for controlling program, read-out or erase operation may be first read out at Step S120, repair address information may be read out next at Step S130, and lastly, an operation of reading out bad block information may be performed at Step S140. Then, the semiconductor memory device generates predetermined levels of operation voltages according to the operation setting information read from the CAM cells, redundancy paths are set according to the repair address information, and bad memory blocks are set to not be used, according to the bad block information.

After the CAM read operation has been performed, the semiconductor memory device enables a CAM read completion signal AUTORDDONE indicating that the CAM read operation has been completed at Step S150, and, in response to this, outputs, to a controller, a ready/busy signal R/B in a ready state indicating that a subsequent operation can be performed at Step S160.

The controller detects that the ready/busy signal R/B outputted from the semiconductor memory device is in the ready state, and transmits a command for performing an additional operation, for example, a read/program/erase operation, thus allowing the semiconductor memory device to perform a normal operation at Step S170.

Referring to FIG. 1B, after the CAM read operation has been performed, the ready/busy signal R/B is outputted with the ready state indicating that a subsequent operation is allowed to be performed when the CAM read completion signal AUTORDDONE indicating that the CAM read operation has been completed is enabled. In this regard, when a voltage level of the external power supply voltage is unstable or the CAM read operation is performed in a state in which data in the CAM cell is unstable due to a particular reason, incorrect option information may be read out. In this case, a next program, read or erase operation is performed based on the incorrect option information, whereby the reliability of the entire memory system deteriorates.

### SUMMARY

Various embodiments are directed to a semiconductor memory device which is able to read out, when power to the device is turned on (“power-on”), option information and error check information stored in a CAM cell, and determine, based on the error check information, whether there is an error on the option information, and an operating method thereof.

Also, various embodiments are directed to a semiconductor memory device which is able to read out, in response to a CAM read command, the option information and the error check information stored in the CAM cell, and disables, when based on this an error is detected, a complete signal for the CAM read command, and an operating method thereof.

In an embodiment, a semiconductor memory device may include: a memory cell array comprising: a Content Addressable Memory (CAM) cell block including CAM cells storing option information including operation setting Information for controlling an operation of the semiconductor memory device, and error check information for the operation setting information; and memory blocks including memory cells for storing data; an error detection unit suitable for reading out, in response to a CAM read command, the operation setting information and the error check information stored in the CAM cell block and outputting an error detection signal indicating whether there is an error; and a control logic suitable for determining and outputting a state of a ready/busy signal depending on the error detection signal.

In an embodiment, a method of operating a semiconductor memory device may include: storing, in a Content Addressable Memory (CAM) cell, option information including operation setting Information for controlling an operation of the semiconductor memory device, and error check information for the operation setting information; reading out, in response to a CAM read command, the operation setting information and the error check information stored in the CAM cell block, and outputting an error detection signal indicating whether there is an error; and determining and outputting a state of a ready/busy signal depending on the error detection signal.

In an embodiment, a memory system may include: a controller suitable for transmitting a Content Addressable Memory (CAM) read command for an initialization operation; and a semiconductor memory device including a CAM cell block that stores option information including operation setting information for controlling an operation of the semiconductor memory device, and error check information for the operation setting information, the semiconductor memory device suitable for reading out, in response to the CAM read command, the operation setting Information and the error check information stored in the CAM cell block, and determining and output a state of a ready/busy signal, wherein the controller transmits an additional command depending on the state of the ready/busy signal.

In accordance with embodiments, a semiconductor memory device reads out, in response to a CAM read command when power-on, option information and error check information stored in a CAM cell, and disables, when based on this an error is detected, a complete signal for the CAM read command, thus preventing a malfunction which may occur later, thereby protecting the semiconductor memory device from an abnormal operation, and enhancing the reliability of the entire memory system.

### BRIEF DESCRIPTION OF THE DRAWINGS

FIGS. 1A and 1B are a flowchart and a timing diagram for describing a CAM read operation of a semiconductor memory device according to a conventional art.

FIG. 2 is a block diagram of a semiconductor memory device according to an embodiment of the present invention.

FIG. 3 is a diagram of a CAM cell block of FIG. 2.

FIG. 4 is a diagram describing a page of the CAM cell block of FIG. 3.

FIG. 5 is a detailed block diagram describing a partial configuration of a control logic of FIG. 2.

FIG. 6 is a circuit diagram describing a CAM read completion signal generation unit of FIG. 5.

FIGS. 7A and 7B are timing diagrams describing an operation of the control logic of FIG. 5.

FIG. 8 is a flowchart of a CAM read operation of the semiconductor memory device according to an embodiment of the present invention.

FIG. 9 is a block diagram illustrating a memory system including the semiconductor memory device shown in FIG. 2, according to an embodiment of the present invention.

FIG. 10 is a block diagram illustrating an application of the memory system shown in FIG. 9, according to an embodiment of the present invention.

FIG. 11 is a block diagram illustrating a computing system including the memory system shown in FIG. 10, according to an embodiment of the present invention.

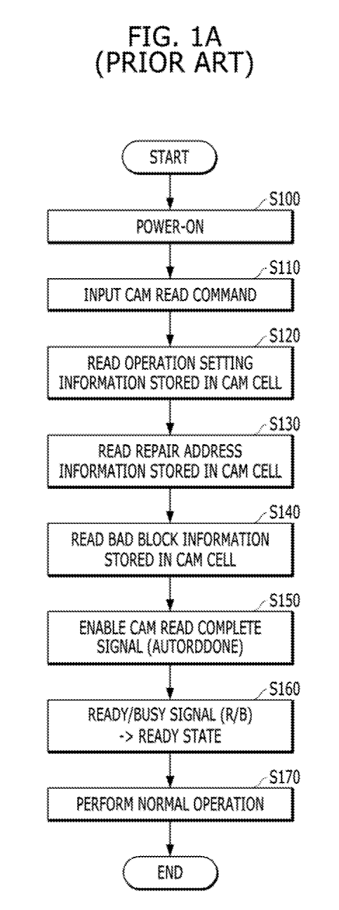

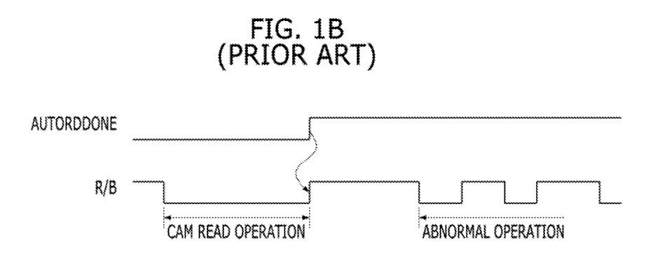

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of the present invention. It is also noted that in this specification, “connected/coupled” refers to one component not only directly coupling another component but also indirectly coupling another component through an intermediate component. It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. In addition, it will also be understood that when an element or layer is referred to as being “between” two elements or layers, it can be the only element or layer between the two elements or layers, or one or more intervening elements or layers may also be present.

It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or groups thereof.

The terminology used herein is for the purpose of describing particular embodiments only and is not intended to be limiting of the present disclosure. Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, the various embodiments of the present disclosure will be described in details with reference to attached drawings.

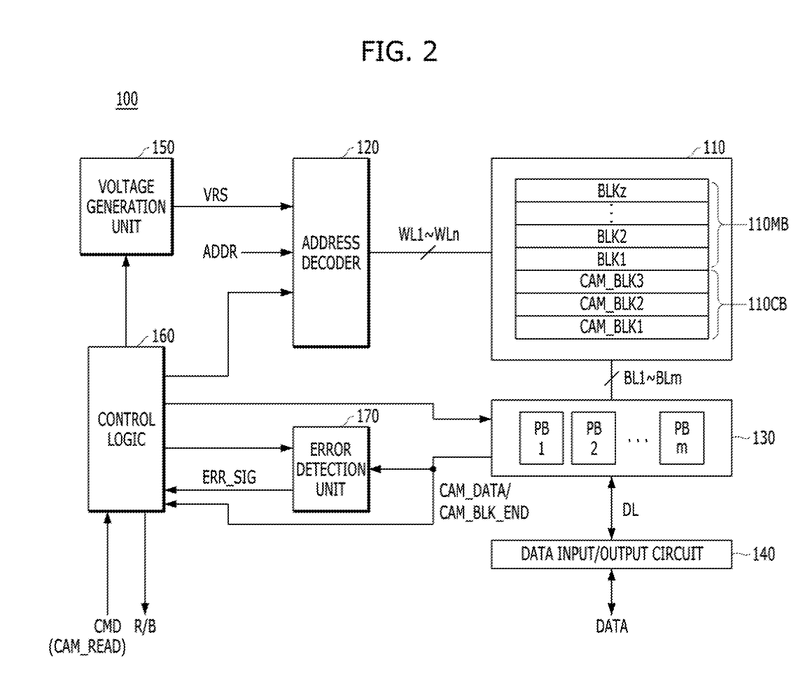

Referring to FIG. 2, a semiconductor memory device 100 according to an embodiment of the present invention includes a memory cell array 110, an address decoder 120, a read/write circuit 130, a date input/output circuit 140, a voltage generation unit 150, a control logic 160, and an error detection unit 170.

The memory cell array 110 may be coupled to the address decoder 120 through word lines WL1 to WLn. The memory cell array 110 may be coupled to the read/write circuit 130 through bit lines BL1 to BLm. The memory cell array 110 may include a main block group 110 MB which may include memory blocks BLK1 to BLKz each including a plurality of memory cells, and a CAM cell block group 110CB which may include CAM cell blocks CAM_BLK1 to CAM_BLK3 each including a plurality of CAM cells. The memory cells and the CAM cells may have substantially the same structure. The CAM cell blocks CAM_BLK1 to CAM_BLK3 may store various kinds of option information needed for the operations of the semiconductor memory device 100. The option information may include operation setting information for at least one of a program, read-out and erase operation, repair address information and bad block information.

In an embodiment, the CAM cell blocks CAM_BLK1 to CAM_BLK3 may store not only various kinds of the option Information needed for the operations of the semiconductor memory device 100 but also additional error check information for the option information. Hereinafter, for illustration purposes, the case where the operation setting information for controlling the operation of the semiconductor memory device 100 and the error check information for the operation setting information may be stored in a first CAM cell block CAM_BLK1, the repair address information may be stored in a second CAM cell block CAM_BLK2, and the bad block information may be stored in a third CAM cell block CAM_BLK3 will be described as an example. Although, in the present embodiment, the case where only the error check information for the operation setting information may be stored is illustrated as an example, in another embodiment, error check information for the repair address Information and/or error check information for the bad block information may be respectively stored in the second CAM cell block CAM_BLK2 and the third CAM cell block CAM_BLK3.

A plurality of memory cells and CAM cells arranged in a row direction may be coupled to the word lines WL1 to WLn. Memory cells and CAM cells arranged in a column direction may be coupled to the bit lines BL1 to BLm. Each of the memory cells and CAM cells may be operated as a single level cell (SLC) or a multi level cell (MLC). In an embodiment, the memory cells and CAM cells may be a nonvolatile memory cell.

Each of the memory blocks BLK1 to BLKz and CAM cell blocks CAM-BLK1 to CAM_BLK3 of the memory cell array 110 may include a plurality of cell strings, each of which may be coupled to the bit lines BL1 to BLm. Each of the plurality of cell strings may include a drain select transistor, a plurality of memory cells, and a source select transistor, all of which may be coupled in series between a corresponding bit line and a source line.

The address decoder 120, the read/write circuit 130, the data input/output circuit 140, the voltage generation unit 150, and the control logic 160 may be operated as peripheral circuits for driving the memory cell array 110.

The address decoder 120 may be coupled to the memory cell array 110 through the word lines WL1 to WLn. The address decoder 120 may be configured to be operated in response to a control of the control logic 160. The address decoder 120 may receive an address ADDR from an external device. The address decoder 120 may decode the address ADDR to generate a block address, and select, according to the generated block address, one memory block among the plurality of memory blocks BLK1 to BLKz and CAM cell blocks CAM_BLK1 to CAM_BLK3 of the memory cell array 110. The address decoder 120 may decode the address ADDR to generate a row address, and select, according to the generated row address, one of the word lines WL1 to WLn coupled to the selected memory block. The address decoder 120 may include a block decoder, a row decoder, an address buffer, etc.

The read/write circuit 130 may be coupled to the memory cell array 110 through the bit lines BL1 to BLm and coupled to the data input/output circuit 140 through data lines DL. The read/write circuit 130 may be configured to be operated in response to the control of the control logic 160.

During a program operation, the read/write circuit 130 may receive program data DATA from the data input/output circuit 140 to transmit the program data DATA to the bit lines BL1 to BLm. The transmitted data may be programmed to memory cells coupled to a selected word line. During a read operation, the read/write circuit 130 may read, through the bit lines BL1 to BLm, data from the memory cells coupled to the selected word line to output the read data DATA to the data input/output circuit 140 through the data lines DL. During an erase operation, the read/write circuit 130 may float the bit lines BL1 to BLm. In an embodiment, the read/write circuit 130 may include a plurality of page buffers PB1 to PBm which respectively may correspond to the bit lines BL1 to BLm and may be coupled to the memory cell array 110 through the bit lines BL1 to BLm. Each of the plurality of page buffers PB1 to PBm may include a plurality of latches.

The data input/output circuit 140 may be coupled to the read/write circuit 130 through the data lines DL. The data input/output circuit 140 may operate in response to the control of the control logic 160. The data input/output circuit 140 communicates data DATA with the external device. During the program operation, the data input/output circuit 140 may receive program data DATA from the external device to transmit the program data DATA to the read/write circuit 130. During to the read operation, the data input/output circuit 140 may receive data DATA read from the read/write circuit 130 to output the read data DATA to the external device.

The voltage generation unit 150 may generate operation voltages VRS for program/read/erase operations in response to the control of the control logic 160. The operation voltages VRS may include an erase voltage VERASE, a program voltage VPGM, a read voltage VREAD, a pass voltage VPASS, source line voltages VDSL and VSSL, a common source voltage VSL, etc.

The control logic 160 may be coupled to the address decoder 120, the read/write circuit 130, the data input/output circuit 140, the voltage generator 150, and the error detection unit 170. The control logic 160 may be configured to receive a command CMD through an Input/output buffer (not shown) of the semiconductor memory device 100 and control the overall operation of the semiconductor memory device 100 in response to the command CMD. The control logic 160 may control, in response to a command CMD corresponding to a CAM read command CAM_READ when power-on, the address decoder 120, the read/write circuit 130, and the voltage generation unit 150. The control logic 160 may read out option information read from the CAM cell blocks CAM_BLK1 to CAM_BLK3 to store the option information in an internal register (not shown). Furthermore, the control logic 160 may use the option information stored in the register to generate control signals for controlling the overall operation of the semiconductor memory device 100.

In the present embodiment, the control logic 160 may perform, in response to the command CMD corresponding to the CAM read command CAM_READ when power-on, a CAM read operation to read out the operation setting information and the error check information for the operation setting information stored in the first CAM cell block CAM_BLK_1. In addition, in response to an error detection signal ERR_SIG output from the error detection unit 170, the control logic 160 may output a ready/busy signal R/B indicating a high-level fixed state (hereinafter, referred to as a ‘high-stuck state’) to an external controller (not shown), or may additionally perform an operation of reading out repair address information stored in the second CAM cell block CAM_BLK2 and bad block information stored in the third CAM cell block CAM_BLK3 terminate the CAM read operation, and then output a ready/busy signal R/B indicating a ready state to the external controller (not shown).

When the error detection signal ERR_SIG is enabled to a logic high level, in other words, when it indicates that there is an error, the control logic 160 may output the ready/busy signal R/B indicating the high-stuck state. The control logic 160 may terminate the CAM read operation without performing the operation of reading out the repair address information stored in the second CAM cell block CAM_BLK2 and the bad block information stored in the third CAM cell block CAM_BLK3. In this case, since the ready/busy signal R/B is in the high-stuck state, even if the controller sends a command for an additional operation, the semiconductor memory device 100 may not perform the additional operation, thus preventing a malfunction from occurring. In the case where the semiconductor memory device 100 is continuously retained in the high-stuck state, the controller may re-transmit, after a predetermined time has lapsed, a CAM read command CAM_READ or a command CMD corresponding to a power booting command including the CAM read command CAM_READ to the semiconductor memory device 100 so that a power booting sequence operation or a CAM read operation can be re-performed.

On the other hand, when the error detection signal ERR_SIG is disabled to a logic low level, in other words, when it indicates that there is no error, the control logic 160 additionally may perform the operation of reading out the repair address information stored in the second CAM cell block CAM_BLK2 and the bad block information stored in the third CAM cell block CAM_BLK3, terminate the CAM read operation, and then output the ready/busy signal R/B indicating the ready state. Therefore, the semiconductor memory device 100 may generate the operation voltages to predetermined levels according to the read-out operation setting information, set redundancy paths according to the repair address information, and set bad memory blocks as not being used, according to the bad block information. Subsequently, a normal operation can be performed.

The error detection unit 170 may store, in response to the control of the control logic 160, the operation setting information and error check information may read out from the first CAM cell block CAM_BLK1 and determine whether there is an error in the operation setting information using the error check information. The error detection unit 170 may output an error detection signal ERR_SIG to the control logic 160 if there is an error. In the present embodiment, the error check information may include a parity bit.

Generally, the control logic 160 may store option information read out from the CAM cell blocks CAM_BLK1 to CAM_BLK3 in the internal register and generate, based on the option information, a control signal for controlling the overall operation of the semiconductor memory device 100. In this regard, when there is an error in the information stored in the CAM cell blocks CAM_BLK1 to CAM_BLK3, or a system error occurs due to instability of the power level, or an error occurs in the process of loading the stored information, a problem may occur in controlling the operation of the semiconductor memory device 100. To prevent this problem, in the present embodiment, the operation setting information and the error check information, e.g., a parity bit, for the operation setting Information may be stored in some of the CAM cell blocks CAM_BLK1 to CAM_BLK3, for example, in the first CAM cell block CAM_BLK1. The parity bit may be a bit used in a conventional error check method. In the error check method, the parity bit of one bit may be added to each word of data to be transmitted in order to check whether an error occurs in the process of transmitting the data.

That is, when reading out the option information from the CAM cell blocks CAM_BLK1 to CAM_BLK3, the error detection unit 170 may also read out and load the error check information along with the option information and determine whether there is an error in the operation setting information. To this end, the error detection unit 170 may have an error detection code (EDC) check function. The error detection unit 170 may determine whether there is an error in the operation setting information and output an error detection signal ERR_SIG to the control logic 160.

For reference, reference symbol ‘CAM_DATA’ shown in FIG. 2 may denote CAM cell data CAM_DATA including all of the operation setting information, the error check information for the operation setting Information, the repair address information, and the bad block information, all of which is read out from the CAM cell blocks CAM_BLK1 to CAM_BLK3. In the present embodiment, among the CAM cell data CAM_DATA, only the operation setting information and the error check information for the operation setting information which are stored in the first CAM cell block CAM_BLK1 may be inputted to the error detection unit 170. Furthermore, reference symbol ‘CAM_BLK_END’ may denote a CAM cell block read completion signal. The CAM cell block read completion signal is enabled when a CAM read operation of reading out information for error detection (that is, the operation setting information for controlling the operation of the semiconductor memory device 100 and the error check information for the operation setting information) from the first CAM cell block CAM_BLK1 is completed, or when the CAM read operation of reading out all of the information from the first to third CAM cell blocks CAM_BLK1 to CAM_BLK3 is completed.

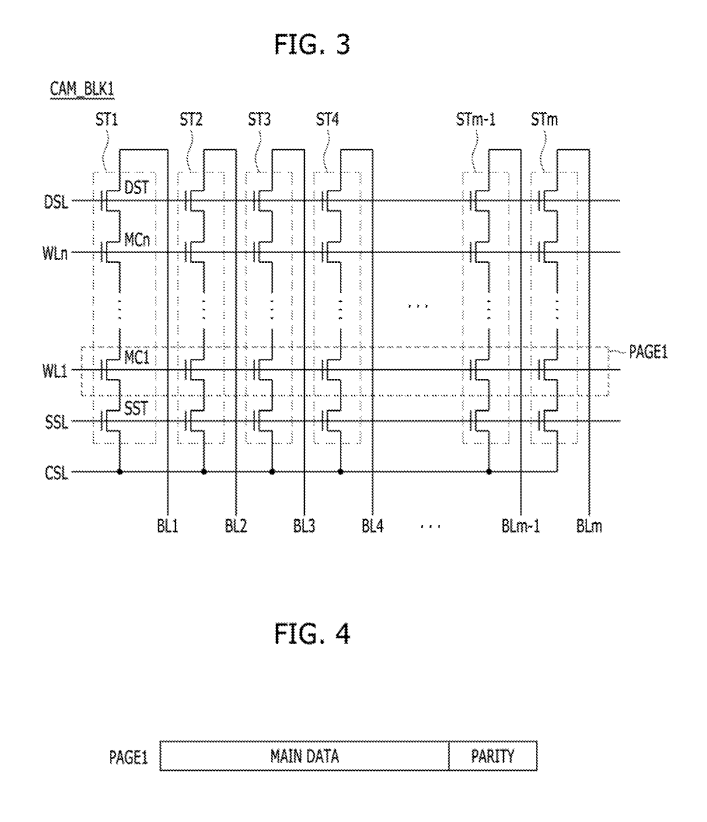

FIG. 3 is a diagram for describing the CAM cell block CAM_BLK1 of FIG. 2. FIG. 4 is a diagram for describing a page PAGE1 of the first CAM cell block CAM_BLK1 of FIG. 3.

Referring to FIG. 3, the first CAM cell block CAM_BLK1 may include a plurality of cell strings ST1 to STm respectively coupled to the bit lines BL1 to BLm. Each of the plurality of cell strings may Include a drain select transistor DST, a plurality of memory cells MC1 to MCn, and a source select transistor SST which may be coupled in series between a corresponding bit line BL and a source line CSL. A gate of the drain select transistor DST may be coupled to a drain select line DSL, and a gate of the source select transistor SST may be coupled to a source select line SSL. The plurality of memory cells MC1 to MCn may be respectively coupled to the word lines WL1 to WLn. A plurality of memory cells coupled to the same word line, for example, the word line WL1 may be defined as a single physical page PAGE1, and such a page may become a basic unit of a program operation or a read operation. For reference, the second CAM cell block CAM_BLK2 and the third CAM cell block CAM_BLK3 may have substantially the same configuration as that of the first CAM cell block CAM_BLK1.

Referring to FIG. 4, the page PAGE1 of the first CAM cell block CAM_BLK1 may store operation setting information MAIN_DATA for operation control and error check information PARITY for the operation setting information. In an embodiment, the operation setting information MAIN_DATA may include operation voltages for controlling a program, read-out or erase operation. The operation voltages may include an erase voltage VERASE, a program voltage VPGM, a read voltage VREAD, a pass voltage VPASS, source line voltages VDSL and VSSL, a common source voltage VSL, etc. In an embodiment, the error check information PARITY may include a parity bit. The parity bit may include information generated based on the operation setting information MAIN_DATA and be added to the operation setting information MAIN_DATA such that the total number of bits with a bit value “one” included in the operation setting information MAIN_DATA may be maintained as even number or odd number.

The error detection unit 170 of FIG. 2 may store the operation setting information MAIN_DATA and the error check information PARITY that are read out from the first CAM cell block CAM_BLK1. Based on the parity bit included in the error check information PARITY, it may be determined whether there is an error in the read-out operation setting Information MAIN_DATA. In an embodiment, the error detection unit 170 may store error information generated during a write operation and compare the error check information PARITY read out during the read operation with the stored error information to determine whether there is an error.

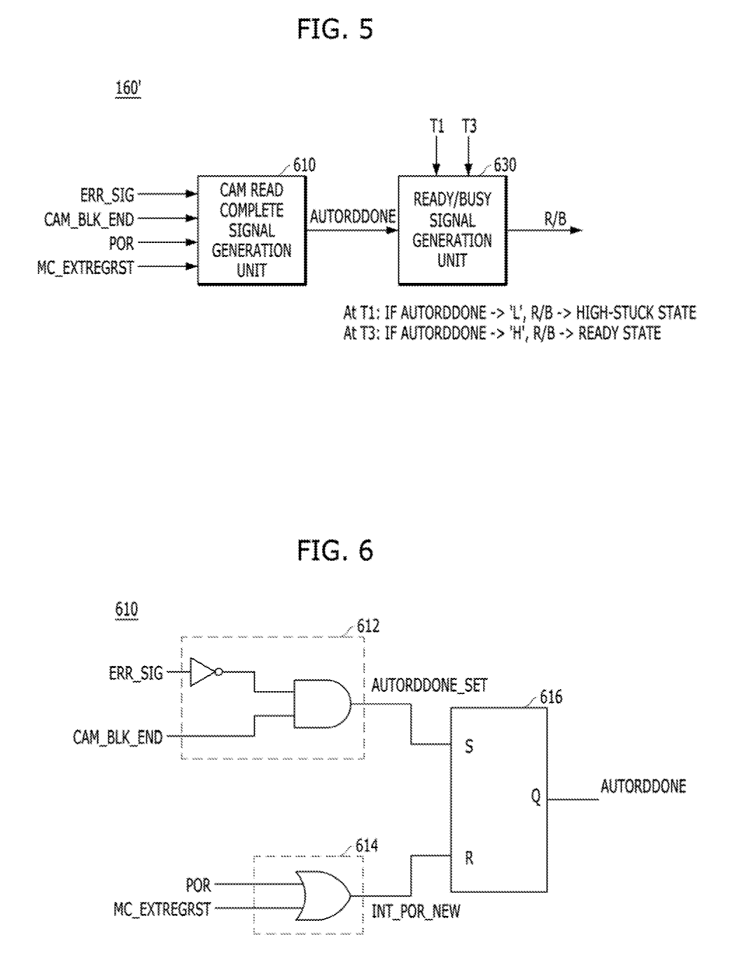

FIG. 5 is a detailed block diagram for describing a partial configuration 160′ of the control logic 160 of FIG. 2. For reference, FIG. 5 illustrates a partial configuration 160′ for embodying characteristics of the present embodiment, out of the entire configuration of the control logic 160 of FIG. 2.

Referring to FIG. 5, the control logic 160′ may include a CAM read completion signal generation unit 610 and a ready/busy signal generation unit 630.

The CAM read completion signal generation unit 610 may generate a CAM read completion signal AUTORDDONE in response to an error detection signal ERR_SIG, a CAM cell block read completion signal CAM_BLK_END, a power-on signal POR and a register reset signal MC_EXTREGRST. In more detail, the CAM read completion signal AUTORDDONE may be set in response to the error detection signal ERR_SIG and the CAM cell block read completion signal CAM_BLK_END and may be reset in response to the power-on signal POR or the register reset signal MC_EXTREGRST.

The ready/busy signal generation unit 630 may output, in response to the CAM read completion signal AUTORDDONE, a ready/busy signal R/B indicating a high-stuck state to the external controller (not shown), or may output a ready/busy signal R/B indicating a ready state to the external controller. In more detail, the ready/busy signal generation unit 630 may output the ready/busy signal R/B with the high-stuck state, when the CAM read completion signal AUTORDDONE is disabled at a first timing T1. The ready/busy signal generation unit 603 may output the ready/busy signal R/B with the ready state, when the CAM read completion signal AUTORDDONE is enabled at a third timing T3.

For reference, the first timing T1 may refer to as a time at which, after power-on T0, the operation of reading out, from the first CAM cell block CAM_BLK1, the operation setting information for controlling the operation of the semiconductor memory device 100 and the error check information for the operation setting information may be completed. The third timing T3 may refer to as a time at which the operation of reading out all information from the first to third CAM cell blocks CAM_BLK1 to CAM_BLK3 may be completed. A second timing T2 may refer to as any timing between the first timing T1 and the third timing T3. The error detection signal ERR_SIG may be a signal which is enabled to the logic high level when the error check Information PARITY indicates that there is an error. The register reset signal MC_EXTREGRST may be a signal which is enabled at the second timing T2. The CAM cell block read completion signal CAM_BLK_END may be a signal which is enabled at the first timing T1 and the third timing T3.

FIG. 6 is a circuit diagram for describing the CAM read completion signal generation unit 610 of FIG. 5.

Referring to FIG. 6, the CAM read completion signal generation unit 610 may include a set signal generation unit 612, a reset signal generation unit 614, and a latch unit 616.

The set signal generation unit 612 may generate a set signal AUTORDDONE_SET which is enabled in response to the error detection signal ERR_SIG and the CAM cell block read completion signal CAM_BLK_END. In more detail, the set signal generation unit 612 may mask, when the error detection signal ERR_SIG is enabled to the logic high level, the CAM cell block read completion signal CAM_BLK_END and may output it as a set signal AUTORDDONE_SET. The set signal generation unit 612 may output, when the error detection signal ERR_SIG is disabled to the logic low level, the CAM cell block read completion signal CAM_BLK_END as a set signal AUTORDDONE_SET. In other words, the set signal generation unit 612 may output, in the case where the error check information PARITY indicates that there is an error, a set signal AUTORDDONE_SET such that it is disabled. The set signal generation unit 612 may output, in the case where the error check information PARITY indicates that there is no error, a set signal AUTORDDONE_SET such that it is enabled at the first timing T1 and the third timing T3.

The reset signal generation unit 614 may generate a reset signal INT_POR_NEW which is enabled in response to a power-on signal POR or a register reset signal MC_EXTREGRST. Although in the conventional art the power-on signal POR has been used as a reset signal, in the present embodiment, the reset signal INT_POR_NEW that is enabled in response to the power-on signal POR or the register reset signal MC_EXTREGRST may be used as a reset signal.

The latch unit 616 may generate a CAM read completion signal AUTORDDONE which is set in response to the set signal AUTORDDONE_SET and is reset in response to the reset signal INT_POR_NEW.

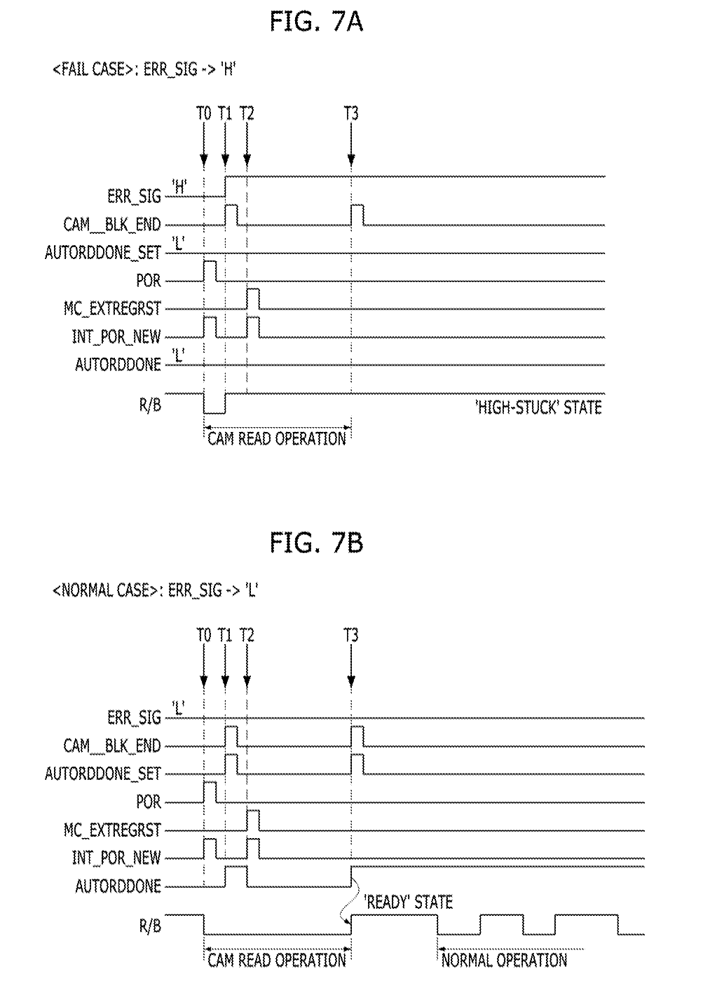

Hereinafter, the CAM read completion signal AUTORDDONE and the ready/busy signal R/B which are output from the control logic 160′ shown in FIGS. 5 and 6 will be described with reference to FIGS. 7A and 7B.

FIGS. 7A and 7B are timing diagrams for describing the operation of the control logic 160′ of FIG. 5.

Referring to FIG. 7A, it illustrates the case where the error detection signal ERR_SIG is enabled to the logic high level, that is, the case where the error check information for the operation setting information stored in the first CAM cell block CAM_BLK1 indicates that there is an error in the operation setting information.

In this case, since the error detection signal ERR_SIG is enabled to the logic high level, the set signal generation unit 612 of the CAM read completion signal generation unit 610 may output a set signal AUTORDDONE_SET such that it is disabled. Therefore, the latch unit 616 of the CAM read completion signal generation unit 610 may output a CAM read completion signal AUTORDDONE that is disabled to the logic low level. The ready/busy signal generation unit 630 may output, in the case where the CAM read completion signal AUTORDDONE is disabled to the logic low level at the first timing T1, the ready/busy signal R/B indicating the high-stuck state to the external controller (not shown).

Thereafter, the control logic 160 may terminate the CAM read operation without performing the operation of reading out the repair address information stored in the second CAM cell block CAM_BLK2 and the bad block information stored in the third CAM cell block CAM_BLK3. In this case, since the ready/busy signal R/B is in the high-stuck state, even if the controller sends a command for an additional operation, the semiconductor memory device 100 does not perform the additional operation, thus preventing a malfunction from occurring. In the case where the semiconductor memory device 100 is continuously retained in the high-stuck state, the controller may re-transmit, after a predetermined time has lapsed, a CAM read command CAM_READ or a command CMD corresponding to a power booting command including the CAM read command CAM_READ to the semiconductor memory device 100 so that a power booting sequence operation or a CAM read operation can be re-performed.

Referring to FIG. 7B, it illustrates the case where the error detection signal ERR_SIG is disabled to the logic low level, that is, the case where the error check information for the operation setting information stored in the first CAM cell block CAM_BLK1 indicates that there is no error in the operation setting information.

In this regard, since the error detection signal ERR_SIG is disabled to the logic low level, the set signal generation unit 612 of the CAM read completion signal generation unit 610 may output a CAM block read completion signal CAM_BLK_END that is enabled at the first timing T1 and the third timing T3 as the set signal AUTORDDONE_SET as it is. Therefore, the latch unit 616 of the CAM read completion signal generation unit 610 may output a CAM read completion signal AUTORDDONE which is set at the first timing T1, reset at the second timing T2, and then set again at the third timing T3. In this regard, the control logic 160 may additionally perform, after the first timing, the operation of reading out the repair address information stored in the second CAM cell block CAM_BLK2 and the bad block information stored in the third CAM cell block CAM_BLK3. The control logic 160 may terminate the CAM read operation at the third timing T3. The ready/busy signal generation unit 630 may output, in the case where the CAM read completion signal AUTORDDONE is enabled at the third timing T3, the ready/busy signal R/B indicating the ready state to the external controller (not shown).

Therefore, the control logic 160 may perform an operation of setting the semiconductor memory device 100 such that the operation voltages may be generated in predetermined levels according to the read operation setting information, a redundancy path may be set according to the repair address information, and a bad memory block according to the bad block information may not be used. Subsequently, a normal operation can be performed.

Hereinafter, the operation of a semiconductor memory device according to an embodiment of the present invention will be described with reference to FIGS. 2 and 5 through 7B.

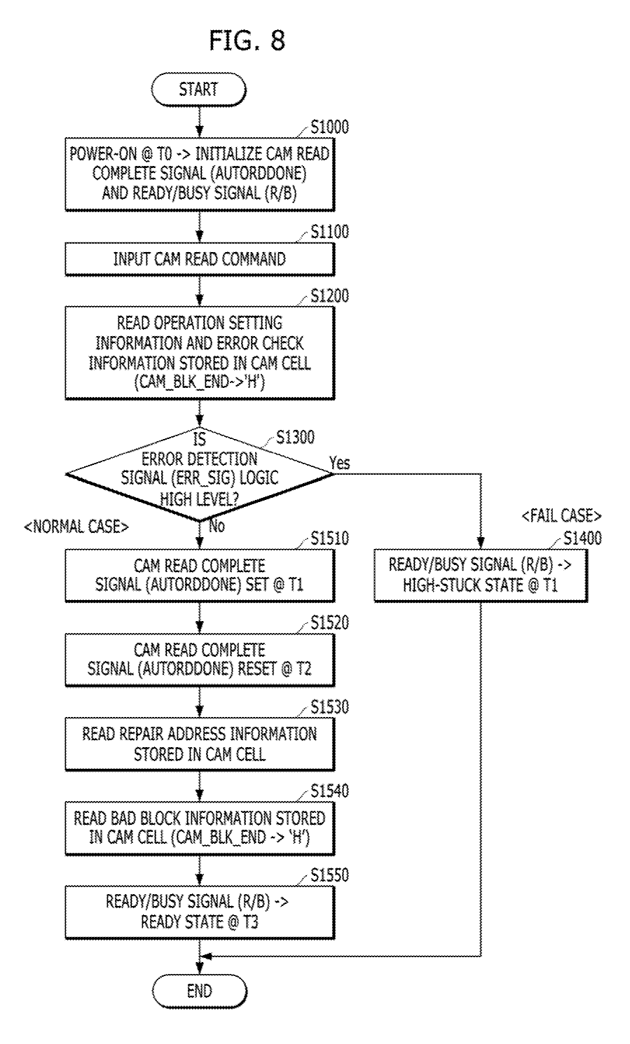

FIG. 8 is a flowchart for describing the CAM read operation of the semiconductor memory device according to an embodiment of the present invention.

Referring to FIG. 8, when an external power supply voltage begins to be supplied to the semiconductor memory device 100, a power-on signal POR may be enabled at Step S1000, and a CAM read command CAM_READ for reading out option information stored in the CAM cells may be inputted from the external controller at Step S1100. When the power-on signal POR is enabled, the CAM read completion signal AUTORDDONE and the ready/busy signal R/B may be initialized.

The semiconductor memory device 100 may perform, in response to the CAM read command, the CAM read operation for reading out the operation setting information stored in the first CAM cell block CAM_BLK1 and the error check information for the operation setting information at Step S1200. For reference, at the first timing T1 at which the CAM read operation of reading out the operation setting information stored in the first CAM cell block CAM_BLK1 and the error check information for the operation setting information is completed, the CAM cell bock read completion signal CAM_BLK_END may be enabled.

The error detection unit 170 may determine whether there is an error in the operation setting information based on the operation setting information and the error check information read out from the first CAM cell block CAM_BLK1 to output an error detection signal ERR_SIG to the control logic 160.

When the error detection signal ERR_SIG is enabled to the logic high level (“Yes” of step S1300), in other words, when it indicates that there is an error, the control logic 160 may output a ready/busy signal R/B with the high-stuck state at Step S1400. The control logic 160 may terminate the CAM read operation without performing the operation of reading out the repair address information stored in the second CAM cell block CAM_BLK2 and the bad block information stored in the third CAM cell block CAM_BLK3. In this case, since the ready/busy signal R/B is in the high-stuck state, even if the controller sends a command for an additional operation, the semiconductor memory device 100 does not perform the additional operation, thus preventing a malfunction from occurring. In the case where the semiconductor memory device 100 is continuously retained in the high-stuck state, the controller may re-transmit, after a predetermined time has lapsed, a CAM read command CAM_READ or a command CMD corresponding to a power booting command including the CAM read command CAM_READ to the semiconductor memory device 100 so that a power booting sequence operation or a CAM read operation can be re-performed.

On the other hand, when the error detection signal ERR_SIG is disabled to a logic low level (“No” of step S1300), in other words, when it indicates that there is no error, the control logic 160 may set the CAM read completion signal AUTORDDONE at the first timing T1 at Step S1510, and may reset the CAM read completion signal AUTORDDONE at the second timing T2 at Step S1520. The semiconductor memory device 100 may additionally perform an operation of reading out the repair address information stored in the second CAM cell block CAM_BLK2 at Step S1530, and an operation of reading out the bad block information stored in the third CAM cell block CAM_BLK3 at Step S1540. The semiconductor memory device 100 may be set such that the operation voltages may be generated in predetermined levels according to the operation setting information read out from the CAM cell blocks CAM_BLK1 to CAM_BLK3, a redundancy path may be set according to the repair address Information, and a bad memory block according to the bad block information may be not used.

After the above-mentioned CAM read operation is performed, the control logic 160 may set again the CAM read completion signal AUTORDDONE at the third timing T3 and output, in response to the CAM read completion signal AUTORDDONE enabled at the third timing T3, the ready/busy signal R/B with a ready state Indicating that a next operation is allowed to be performed at Step S1550.

Therefore, the controller may detect that the ready/busy signal R/B outputted from the semiconductor memory device is in the ready state, and transmit a command for performing an additional operation, for example, a read/program/erase operation, thus allowing the semiconductor memory device to perform a normal operation.

As described above, a semiconductor memory device according to an embodiment of the present invention can read out, when power-on, option information and error check Information that are stored in CAM cells and determine whether there is an error in the option information based on the error check information. Furthermore, in the case where an error is not detected, a complete signal for the CAM read command is enabled so as to allow a normal operation to be performed. In the case where an error is detected, a complete signal for the CAM read command is disabled, thus preventing a malfunction which may occur later. Accordingly, the semiconductor memory device can be protected from an abnormal operation, and the reliability of the entire memory system can be enhanced.

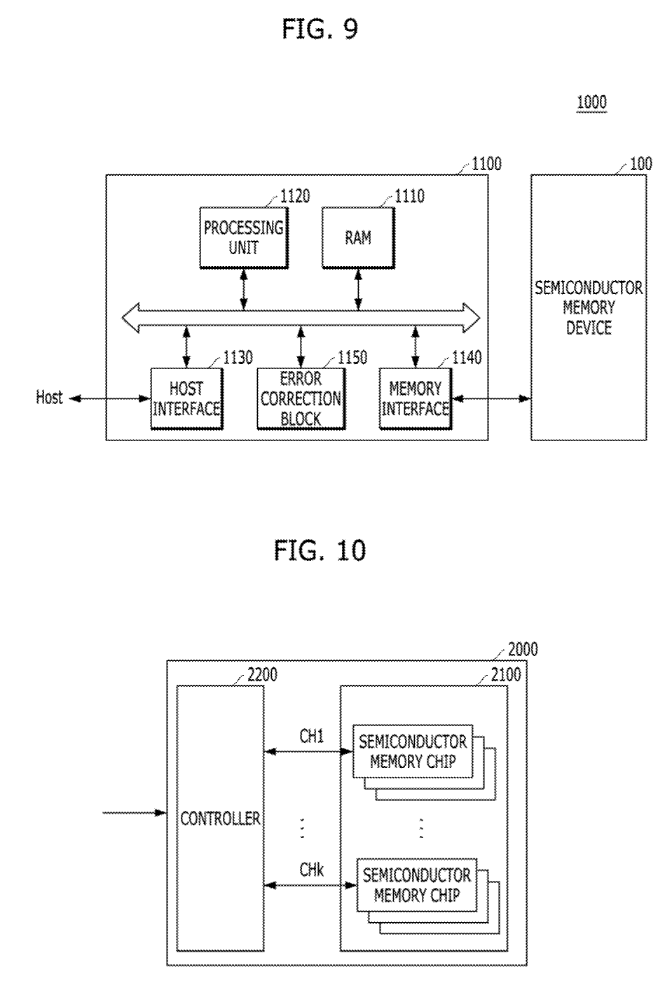

FIG. 9 is a block diagram illustrating a memory system including the semiconductor memory device 100 shown in FIG. 2.

Referring to FIG. 9, the memory system 1000 according to an embodiment of the present invention may include the semiconductor memory device 100 and a controller 1100.

Since the semiconductor memory device 100 is configured and manufactured as described above with reference to FIG. 2, a detailed description thereof will be omitted.

The controller 1100 may be connected to a host and the semiconductor memory device 100 and may be suitable for accessing the semiconductor memory device 100 in response to a request from the host. For example, the controller 1100 may be suitable for controlling read, write, erase and background operations of the semiconductor memory device 100. The controller 1100 may be suitable for performing an interfacing between the semiconductor memory device 100 and the host. The controller 1100 may be suitable for operating a firmware to control the semiconductor memory device 100.

The controller 1100 may include random access memory (RAM) 1110, a central processing unit (CPU) 1120, a host interface 1130, a memory interface 1140, and an error correction code (ECC) block 1150 operatively linked via an internal bus. The RAM 1110 may be used as at least one of an operation memory of the CPU 1120, a cache memory between the memory device 1200 and the host, and a buffer memory between the memory device 1200 and the host. The CPU 1120 may control the overall operation of the controller 1100. The controller 1100 may temporarily store program data provided from the host during a read operation.

The host interface 1130 may include a protocol for data exchange between the host and the controller 1100. For example, the controller 1100 may communicate with the host through at least one of various protocols such as a Universal Serial Bus (USB) protocol, a Multimedia Card (MMC) protocol, a Peripheral Component Interconnection (PCI) protocol, a PCI-Express (PCI-E) protocol, an Advanced Technology Attachment (ATA) protocol, a Serial-ATA protocol, a Parallel-ATA protocol, a Small Computer Small Interface (SCSI) protocol, an Enhanced Small Disk Interface (ESDI) protocol, an Integrated Drive Electronics (IDE) protocol and a private protocol.

The memory interface 1140 may be suitable for performing the interfacing with the semiconductor memory device 100. For example, the memory Interface 1140 may include a NAND flash interface or a NOR flash interface.

The ECC block 1150 may be suitable for detecting and correcting errors in data read out from the semiconductor memory device 100 using an error correcting code. The CPU 1120 may control a read voltage according to an error detection result of the ECC block 1150 and control the semiconductor memory device 100 to perform a re-read operation. According to an embodiment of the present invention, the ECC block may be provided as a component of the controller 1100.

The controller 1100 and the semiconductor memory device 100 may be integrated into one semiconductor device. According to an embodiment of the present invention, the controller 1100 and the semiconductor memory device 100 may be integrated into a single semiconductor device to form a memory card such as a personal computer memory card international association (PCMCIA), a compact flash card (CF), a smart media card (SMC), a memory stick, a multimedia card (MMC), a reduced size MMC (RS-MMC), a micro-MMC, a secure digital (SD) card, a mini-SD, a micro-SD, an SDHC, a universal flash storage device (UFS), etc.

The controller 1100 and the semiconductor memory device 100 may be Integrated into one semiconductor device to form a semiconductor drive, e.g., a Solid State Drive (SSD). The semiconductor drive (e.g., SSD) may include a storage device configured to store data in a semiconductor memory. When the memory system 2000 is used as the semiconductor drive (SSD), the operating speed of the host coupled to the memory system 1000 may be significantly improved.

In another example, the memory system 1000 may be used as one of various components in an electronic device, such as a computer, an ultra mobile PC (UMPC), a workstation, a net-book, personal digital assistants (PDAs), a portable computer, a web tablet, a wireless phone, a mobile phone, a smart phone, an e-book, a portable multimedia player (PMP), a portable game machine, a navigation device, a black box, a digital camera, a three-dimensional (3D) television, a digital audio recorder, a digital audio player, a digital picture recorder, a digital picture player, a digital video recorder, a digital video player, a device for transmitting/receiving information in wireless environment, one of various electronic devices for home networks, one of various electronic devices for computer networks, one of various electronic devices for telematics networks, an RFID device and/or one of various devices for computing systems, and the like.

In an exemplary embodiment, the semiconductor memory device 100 or the memory system 1000 may be packaged in a variety of ways. For example, in some embodiments, the semiconductor memory device 100 or the memory system 1000 may be packaged using various methods such as a package on package (PoP), ball grid arrays (BGAs), chip scale packages (CSPs), a plastic leaded chip carrier (PLCC), a plastic dual in line package (PDIP), a die in waffle pack, a die in wafer form, a chip on board (COB), a ceramic dual in line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SIP), a multi chip package (MCP), a wafer-level fabricated package (WFP) and/or a wafer-level processed stack package (WSP), etc.

FIG. 10 is a block diagram illustrating an application 2000 of the memory system 1000 shown in FIG. 9.

Referring to FIG. 10, the memory system 2000 may include a semiconductor memory device 2100 and a controller 2200. The semiconductor memory device 2100 may include a plurality of semiconductor memory chips. The semiconductor memory chips may be divided into a plurality of groups.

In FIG. 10, the plurality of groups in the semiconductor memory chips communicate with the controller 2200 through first to k-th channels CH1 to CHk, respectively. Each of the memory chips may be configured and operated in substantially the same manner as the semiconductor memory device 100 described above with reference to FIG. 2.

Each of the groups in the semiconductor memory chips may communicate with the controller 2200 through a single common channel. The controller 2200 may be configured in substantially the same manner as the controller 1100 described above with reference to FIG. 9 and may control the plurality of memory chips of the semiconductor memory device 2100.

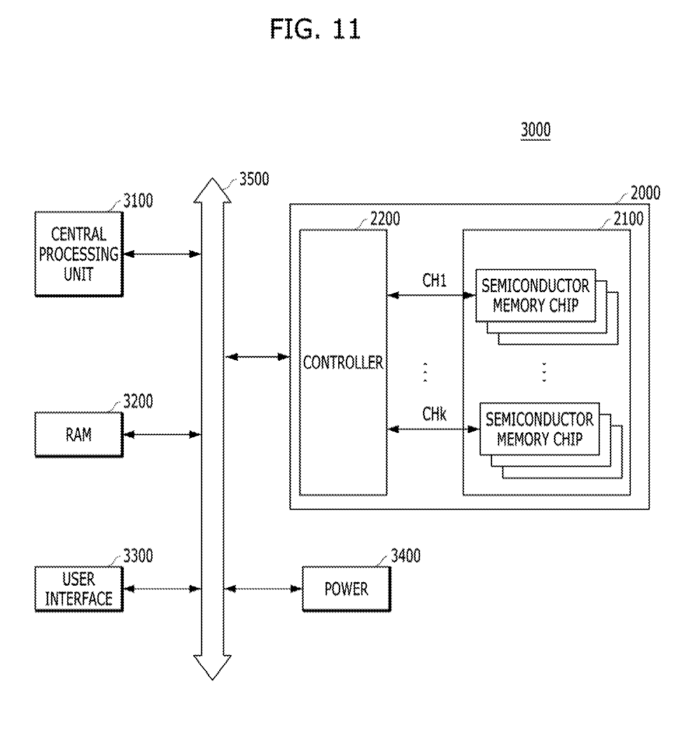

FIG. 11 is a block diagram illustrating a computing system including the memory system shown in FIG. 10.

Referring to FIG. 11, the computing system 3000 may include a central processing unit 3100, random access memory (RAM) 3200, a user interface 3300, a power supply 3400, a system bus 3500, and the memory system 2000.

The memory system 2000 may be electrically connected to the central processing unit 3100, the RAM 3200, the user interface 3300 and the power supply 3400 through the system bus 3500. Data provided through the user interface 3300 or processed by the central processing unit 3100 may be stored in the memory system 2000.

In FIG. 11, the semiconductor memory device 2100 may be coupled to the system bus 3500 through the controller 2200. However, the semiconductor memory device 2100 may be directly coupled to the system bus 3500. Functions of the controller 2200 may be performed by the central processing unit 3100 and the RAM 3200.

FIG. 11 illustrates the memory system 2000 described above with reference to FIG. 10. However, the memory system 2000 may be replaced with the memory system 1000 described above with reference to FIG. 9. In an exemplary embodiment, the computing system 3000 may include both memory systems 1000 and 2000 described above with reference to FIGS. 9 and 10, respectively.

Although various embodiments have been described for illustrative purposes, it will be apparent to those skilled in the art that various changes and modifications may be made without departing from the spirit and scope of the invention as defined in the following claims.

For example, the positions and types of the logic gates and transistors described in the above-described embodiments may be differently implemented depending on the polarities of input signals.

It is also noted, that in some instances, as would be apparent to those skilled in the relevant art to which this invention pertains, a feature or element described in connection with one embodiment may be used singly or in combination with other features or elements of another embodiment, unless specifically indicated otherwise.

What is claimed is:

1. A semiconductor memory device comprising:
a memory cell array comprising: a Content Addressable Memory (CAM) cell block including CAM cells storing option information including operation setting information for controlling an operation of the semiconductor memory device, and error check information for the operation setting information; and memory blocks including memory cells for storing data;
an error detection unit suitable for reading out, in response to a CAM read command, the operation setting information and the error check information stored in the CAM cell block and outputting an error detection signal indicating whether there is an error; and
a control logic suitable for determining and outputting a state of a ready/busy signal depending on the error detection signal.

2. The semiconductor memory device of claim 1, wherein the error check information includes:
a parity bit for checking whether an error occurs.

3. The semiconductor memory device of claim 1, wherein the option information further includes:
repair address information and bad block address information.

4. The semiconductor memory device according to claim 3, wherein the control logic
outputs, when the error detection signal indicates that there is an error, the ready/busy signal with a high-stuck state, and
performs, when the error detection signal indicates that there is no error, an additional operation of reading out the repair address Information and the bad block address information and then outputs the ready/busy signal with a ready state.

5. The semiconductor memory device according to claim 3, wherein the control logic comprises:
a CAM read completion signal generation unit suitable for generating a CAM read completion signal which is set in response to the error detection signal and a CAM cell block read completion signal that is enabled at a first timing or a third timing, and which is reset in response to a power-on signal or a register reset signal that is enabled at a second timing; and
a ready/busy signal generation unit suitable for outputting, depending on the CAM read completion signal, the ready/busy signal with the high-stuck state at the first timing, or the ready/busy signal with the ready state at the third timing.

6. The semiconductor memory device of claim 5, wherein the first timing is a time at which, after power-on, the reading out of the operation setting information and the error check information stored in the CAM cell block is completed, the third timing is a time at which the reading out of the operation setting information and the error check information stored in the CAM cell block, the repair address Information and the bad block address Information is completed, and the second timing is a preset timing between the first timing and the third timing.

7. The semiconductor memory device of claim 5, wherein the CAM read completion signal generation unit comprises:
a set signal generation unit suitable for generating a set signal that is enabled in response to the error detection signal and the CAM cell block read completion signal;
a reset signal generation unit suitable for generating a reset signal that is enabled in response to the power-on signal or the register reset signal; and
a latch unit suitable for outputting the CAM read completion signal that is set in response to the set signal and reset in response to the reset signal.

8. The semiconductor memory device of claim 5, wherein the ready/busy signal generation unit
outputs, when the CAM read completion signal is disabled at the first timing, the ready/busy signal with the high-stuck state, and
outputs, when the CAM read completion signal is enabled at the third timing, the ready/busy signal with the ready state.

9. A method of operating a semiconductor memory device, the method comprising:
storing, in a Content Addressable Memory (CAM) cell, option Information including operation setting information for controlling an operation of the semiconductor memory device, and error check information for the operation setting information;
reading out, in response to a CAM read command, the operation setting information and the error check information stored in the CAM cell block, and outputting an error detection signal indicating whether there is an error; and
determining and outputting a state of a ready/busy signal depending on the error detection signal.

10. The method of claim 9, wherein the error check information includes:
a parity bit for checking whether an error occurs.

11. The method of claim 9, wherein the option information further includes:
repair address information and bad block address information.

12. The method of claim 11, wherein the determining and outputting of the state of the ready/busy signal comprises:
outputting, when the error detection signal indicates that there is an error, the ready/busy signal with a high-stuck state, and
performing, when the error detection signal indicates that there is no error, an additional operation of reading out the repair address Information and the bad block address information and then outputting the ready/busy signal with a ready state.

13. The method of claim 11, wherein the determining and outputting of the state of the ready/busy signal comprises:
generating a CAM read completion signal which is set in response to the error detection signal and a CAM cell block read completion signal that is enabled at a first timing or a third timing, and which is reset in response to a power-on signal or a register reset signal that is enabled at a second timing; and
outputting, depending on the CAM read completion signal, the ready/busy signal with the high-stuck state at the first timing, or the ready/busy signal with the ready state at the third timing.

14. The method of claim 13, wherein the first timing is a time at which, after power-on, the reading out of the operation setting information and the error check information stored in the CAM cell block is completed, the third timing is a time at which the reading out of the operation setting information and the error check information stored in the CAM cell block, the repair address information and the bad block address information is completed, and the second timing is a preset timing between the first timing and the third timing.

15. The method of claim 13, wherein the outputting, depending on the CAM read completion signal, of the ready/busy signal with the high-stuck state at the first timing, or the ready/busy signal with the ready state at the third timing comprises:
outputting, when the CAM read completion signal is disabled at the first timing, the ready/busy signal with the high-stuck state, and
outputting, when the CAM read completion signal is enabled at the third timing, the ready/busy signal with the ready state.

16. A memory system comprising:
a controller suitable for transmitting a Content Addressable Memory (CAM) read command for an initialization operation; and
a semiconductor memory device including a CAM cell block that stores option Information including operation setting information for controlling an operation of the semiconductor memory device, and error check information for the operation setting information, the semiconductor memory device suitable for reading out, in response to the CAM read command, the operation setting information and the error check information stored in the CAM cell block, and determining and output a state of a ready/busy signal,
wherein the controller transmits an additional command depending on the state of the ready/busy signal.

17. The memory system of claim 16,
wherein the semiconductor memory device outputs, when the read error check information Indicates that there is an error, the ready/busy signal with a high-stuck state, and outputs, when the read error check information indicates that there is no error, the ready/busy signal with a ready state, and
wherein the controller re-transmits, when the ready/busy signal outputted from the semiconductor memory device is continuously retained in the high-stuck state, after a predetermined time has lapsed, a CAM read command to the semiconductor memory device.

18. The memory system of claim 16, wherein the semiconductor memory device comprises:
a memory cell array comprising: the CAM cell block including CAM cells storing the option Information including the operation setting information for controlling the operation of the semiconductor memory device, and the error check information for the operation setting information; and memory blocks including memory cells for storing data;
an error detection unit suitable for reading out, in response to the CAM read command, the operation setting information and the error check information stored in the CAM cell block and outputting an error detection signal indicating whether there is an error; and
a control logic suitable for determining and outputting the state of the ready/busy signal depending on the error detection signal.

19. The memory system of claim 18, wherein the option information further includes:
repair address information and bad block address information.

20. The memory system of claim 19, wherein the control logic comprises:
a CAM read completion signal generation unit suitable for generating a CAM read completion signal which is set in response to the error detection signal and a CAM cell block read completion signal that is enabled at a first timing or a third timing, and which is reset in response to a power-on signal or a register reset signal that is enabled at a second timing; and
a ready/busy signal generation unit suitable for outputting, depending on the CAM read completion signal, the ready/busy signal with the high-stuck state at the first timing, or the ready/busy signal with the ready state at the third timing,
wherein the first timing is a time at which, after power-on, the reading out of the operation setting information and the error check information stored in the CAM cell block is completed, the third timing is a time at which the reading out of the operation setting information and the error check information stored in the CAM cell block, the repair address information and the bad block address information is completed, and the second timing is a preset timing between the first timing and the third timing.

21. The memory system of claim 20, wherein the ready/busy signal generation unit
outputs, when the CAM read completion signal is disabled at the first timing, the ready/busy signal with the high-stuck state, and
outputs, when the CAM read completion signal is enabled at the third timing, the ready/busy signal with the ready state.
